(19) United States
(12) Patent Application Publication
(10) Pub. No.: US 2025/0046167 A1
(43) Pub. Date: Feb. 6, 2025

(54) METHOD FOR OPERATING A FOREST FIRE EARLY DETECTION SYSTEM

(71) Applicant: DRYAD NETWORKS GMBH, Eberswalde (DE)

(72) Inventors: Carsten BRINKSCHULTE, Berlin (DE); Marco BÖNIG, Dortmund (DE)

(73) Assignee: DRYAD NETWORKS GMBH, Eberswalde (DE)

(21) Appl. No.: 18/719,873

(22) PCT Filed: Dec. 13, 2022
(86) PCT No.: PCT/EP2022/085709

§ 371 Date: Jun. 14, 2024

(30) Foreign Application Priority Data
Dec. 15, 2021 (DE) 10 2021 133 219.2

(51) Int. Cl. G08B 17/00; G08B 21/18; G08B 25/00; G08B 25/10

(52) U.S. Cl. CPC G08B 17/005; G08B 21/182; G08B 25/007; G08B 25/10

(57) ABSTRACT

The invention relates to a method for operating a forest fire early detection system having the steps of recording a temperature by way of a terminal and sending ID data from the terminal to a server, wherein the position of the terminal is unknown. The invention also relates to a terminal of a forest fire early detection system having a self-sufficient energy supply, a communication device, and a flight control device which is intended and suitable for changing the falling speed of the terminal and/or the direction of flight.

The invention relates to a method for operating a forest fire early detection system having the steps of recording a temperature by way of a terminal and sending ID data from the terminal to a server, wherein the position of the terminal is unknown. The invention also relates to a terminal of a forest fire early detection system having a self-sufficient energy supply, a communication device, and a flight control device which is intended and suitable for changing the falling speed of the terminal and/or the direction of flight.

### PRIOR ART

Systems for early detection of forest fires are known. For this purpose, the area to be monitored is monitored by means of sensors. These sensors are, for example, rotatable cameras, but they have the disadvantage that they are less effective at night. Monitoring from a high orbit by means of an IR camera installed in a satellite has the disadvantage that the satellite is not geostationary, so it requires a certain amount of time to complete one orbit, during which the area is not monitored or the geostationary satellites only supply images having a very low resolution, so that forest fires can only be detected from a certain size, thus usually too late. A satellite is also expensive to purchase, maintain and especially when launching the satellite. Monitoring by mini-satellites in low orbit usually requires a number of satellites, which are also expensive to launch. Satellite monitoring also involves high carbon dioxide emissions during launch.

It makes more sense to monitor the area using a large number of inexpensive sensors arranged in terminals producible in series. These terminals can be produced very inexpensively and often require only a small amount of energy, either because they are not continuously operated or because the sensors themselves are designed to be very energy efficient. The terminals are part of a network, such as a LoRaWAN. The terminals and gateways are distributed throughout the area to be monitored and deliver data to a base station via radio connection.

LoRaWAN uses a star topology network architecture in which all the terminals communicate via the most suitable gateway. These gateways handle routing and, if more than one gateway is within range of a terminal and the local network is congested, they can also redirect communication to an alternative.

However, some other IoT protocols (e.g. ZigBee or Z-Wave) use so-called mesh network architectures to increase the maximum distance of a terminal from a gateway. The terminals in the mesh network forward the messages to each other until they reach a gateway, which transfers the messages to the Internet. Mesh networks program themselves and dynamically adapt to environmental conditions without the need for a master controller or hierarchy. However, in order to be able to forward messages, the terminals of a mesh network have to be ready to receive either constantly or at regular intervals and cannot be put into the idle state for long periods of time. The result is a higher energy requirement of the node terminals for forwarding messages to and from the gateways and a resulting reduction in battery life

The star network architecture of LoRaWAN, on the other hand, allows the terminals to enter the energy-saving idle state for long periods of time, thereby ensuring that the battery of the terminals is put under as little load as possible and can therefore be operated for several years without having to change the battery. The gateway functions as a bridge between simple protocols optimized for battery life (LoRa/LoRaWAN), which are better suited for resource-limit terminals ED, and the Internet Protocol (IP), which is used to provide IoT services and applications. After the gateway has received the data packets from the terminal via LoRa/LoRaWAN, it sends them via the Internet Protocol (IP) to a network server, which in turn has interfaces to IoT platforms and applications.

Currently, these terminals and gateways are individually arranged manually, for example on trees, and their position is recorded to localize an occurring forest fire. However, this method is ineffective, especially in areas that are difficult to access. Above all, this type of installation of the sensor network is very time-consuming and therefore cost-intensive.

It is therefore the object of the invention to provide an improved method for installing a forest fire early detection and/or forest fire risk monitoring system, using which a forest fire early detection and/or forest fire risk monitoring system can be installed and configured inexpensively, quickly, and reliably. It is also an object of the present invention to provide an improved terminal and/or gateway with which a forest fire early detection and/or forest fire risk monitoring system can be installed and configured inexpensively, quickly, and reliably. It is a further object of the invention to provide an improved method for determining the position of a terminal of a forest fire early detection and/or forest fire risk monitoring system, using which a forest fire early detection and/or forest fire risk monitoring system can be installed and configured inexpensively, quickly, and reliably.

### DESCRIPTION OF THE INVENTION

The object is achieved by means of the method for operating a forest fire early detection system according to claim 1. Advantageous embodiments of the invention are set out in the dependent claims.

The method according to the invention for operating a forest fire early detection system has two method steps: In the first method step, the temperature is recorded by a terminal. In particular the temperature of the ambient air and the type and concentration of the gases produced in a forest fire are indicators of a forest fire. The type, composition, and temperature of the gases produced in a forest fire also indicate the occurrence of a forest fire. This makes it possible to detect an emerging forest fire and to combat it at an early stage.

In the second method step, ID data is sent from the terminal to a server. Each terminal arranged in the forest fire early detection system has a separate, i.e., unique ID, by means of which the respective terminal is uniquely identifiable If a forest fire is detected, the terminal sends ID data to the server. The ID data contain the ID of the respective terminal. The server therefore only receives the information as to which terminal within the forest fire early detection system detects a forest fire.

According to the invention, the exact position of the terminal is unknown. For the operation of the forest fire early detection system, precise knowledge of the final position of a terminal in the monitoring area is irrelevant. By means of comprehensive dispensing of the terminals, such a scattered distribution of the terminals in the surveillance area is achieved that an average distribution is at least 2 terminals/ha, preferably at least 5 terminals/ha and particularly preferably at least 10 terminals/ha. It has been shown that such a distribution of terminals in the monitoring area is sufficient to detect a forest fire in the early phase of its development, for example as a smoldering fire. The terminal that detects the forest fire and sends its ID data to the server is not exactly located, but only within a certain area, which is known.

In an advantageous refinement of the invention, the detected temperature is compared with a threshold temperature. The threshold temperature refers to the temperature above which a forest fire occurs. The threshold temperature can optionally be set individually for each device and depends on the climatic conditions to which the monitoring area is exposed. If the temperature detected by the terminal exceeds the threshold temperature, the terminal senses a forest fire. In a further embodiment of the invention, the ID data are sent when the recorded temperature exceeds the threshold temperature. The ID data contain the ID of the respective terminal. The server therefore receives the information as to which terminal within the forest fire early detection system detects a forest fire. In a further aspect of the invention, the exact position of the terminal remains unknown. The terminal that detects the forest fire and sends its ID data to the server is not exactly located, but only within a certain area, which is known.

In a further embodiment of the invention, the communication path from the terminals to the server is routed via a satellite. In addition to using a network, e.g. LoRaWAN, to communicate between the terminals and a server, communication can take place via satellites.

In a further aspect of the invention, the terminals are scattered throughout the monitoring area. In a refinement of the invention, the terminals are distributed scattered throughout the monitoring area. This achieves a comprehensive arrangement of the terminals within the surveillance area, wherein the average density is at least 2 terminals/ha, preferably at least 5 terminals/ha and particularly preferably at least 10 terminals/ha.

In a refinement of the invention, the exact position of the terminals cannot be determined by elements of the forest fire early detection system. For the operation of the forest fire early detection system, precise knowledge of the final position of a terminal in the monitoring area is irrelevant. By means of comprehensive dispensing of the terminals, such a scattered distribution of the terminals in the surveillance area is achieved that an average distribution is at least 2 terminals/ha, preferably at least 5 terminals/ha, and particularly preferably at least 10 terminals/ha. It has been shown that such a distribution of terminals in the monitoring area is sufficient to detect a forest fire in the early phase of its development, for example as a smoldering fire.

In a further embodiment of the invention, the ID data are part of a status message for monitoring the functionality of the terminals and/or part of a warning message. A warning message is the message from the terminal that the terminal has detected a forest fire, while the status message simply signals the functionality of the terminal. Both types of messages are sent from the terminal to the server. The warning message and the status message contain the ID data of the sending device. The status message can optionally contain additional data, for example about the energy reserve of the terminal. The warning message can also optionally contain additional data, for example about the temperature of the ambient air, data about the type and temperature of sensed gases, and/or other measurement data.

In a refinement of the invention, the terminals send status messages to the server at regular intervals. A status message signals the functionality of the terminal. To continuously monitor the functionality of a terminal and thus the forest fire early detection system, each terminal sends status messages at regular intervals, for example every 24 hours. In a further embodiment of the invention, the status messages exclusively comprise data for identifying the terminal, in particular ID data. The ID data are sufficient to confirm the functionality of the terminal.

In an advantageous embodiment of the invention, sending the ID status messages consumes at most half of the energy stored in the terminal. This ensures that the energy storage device of the terminal still has sufficient energy reserves to send a warning message to the server in the event of a forest fire.

In a further embodiment of the invention, the energy for sending a warning message is generated immediately before the warning message is sent. For this purpose, a bimetal lamella and a piezo element are arranged in the terminal. Advantageously, this design combines energy generation and temperature sensor in one device, meaning the terminal can therefore be designed to be cost-effective, lightweight, and robust.

A bimetal lamella has two layers of different metals lying one above the other. The two layers are connected to one another by material bonding or by a form-fitting material. Due to the different coefficients of thermal expansion of the metals used, one of the layers expands more than the other, causing the bimetal lamella to bend when the temperature changes. This deformation of the bimetal lamella due to thermal action is converted into electrical energy by a piezoelectric material, which is deformed or shaken when the bimetal lamella bends. A piezo element generates electrical voltage when force is applied by pressure or vibration, i.e., it uses kinetic energy in the environment. The output power is largely determined by the mechanical deformation of the bending structure. The greater the deflection, the greater the charge and power generated. The bimetal lamella has a transition temperature at which the bimetal lamella changes from a first resting state to a second resting state. The transition temperature of the bimetal lamella is advantageously the threshold temperature at which the terminal detects a forest fire. During the transition, the bimetal lamella generates electrical energy, which is generated to send the communication unit a warning message via the satellite to the server immediately before the warning message is sent.

The object is furthermore achieved by the terminal according to the invention of a forest fire early detection and/or forest fire risk monitoring system. Advantageous embodiments of the invention are set out in the dependent claims.

The terminal according to the invention has a self-sufficient power supply, a communication device, and a flight control device which is intended and suitable for decelerating the falling speed of the terminal and/or gateway.

By means of the self-sufficient energy supply, terminals are autonomously operable without a supply network. Therefore, terminals can be distributed and networked, particularly in impassable areas that cannot be reached with conventional radio networks. In the simplest case, the energy supply is a battery, which can also be designed to be rechargeable. The use of solar cells is somewhat more complex and cost-intensive, but offers a very long service life.

By means of the communication device, messages, for example measurement data, are exchanged between the terminal and the gateway.

By means of the flight control device, the risk of damage to the terminals when the terminals fall and/or fly is reduced, in particular when they impact in their impact position, for example on the ground or in a plant. In a refinement of the invention, the flight control device is a braking device.

In a further embodiment of the invention, the cW value of the terminal is different in two different directions. The cW value is a dimensionless measure of the flow resistance of a body around which a medium flows. A different cW value in different directions causes an angular momentum on the terminal and thus a change in the direction of flight and/or fall of the terminals; the ejected terminals are therefore distributed over a larger area.

In a further embodiment, the flight control device is intended and suitable for changing the air resistance of the terminal. In particular, the flight control device increases the air resistance of the terminal. The risk of damage to the terminals when the terminals fall and/or fly is thus reduced, in particular when they impact in their impact position, for example on the ground or in a plant.

In a further embodiment of the invention, the flight control device has a mechanism which is intended and suitable for changing the orientation of the terminal to a direction of flight of the terminal. The change in orientation also causes a change in the direction of flight and/or fall of the terminals; the ejected terminals are distributed over a larger area. Likewise, the ejected terminals decelerate the falling speed of the terminals, by which the risk of damage to the terminals is reduced.

In a refinement of the invention, the flight control device has a mechanism that is intended and suitable for changing the direction of flight of the terminal; the ejected terminals are distributed over a larger area.

In an advantageous embodiment of the invention, the flight control device has a mechanism which is intended and suitable for decelerating the fall speed and/or flight speed of the terminal during a flight and/or fall of the terminal, by which the risk of damage to the terminals upon impact in their impact position, for example on the ground or in a plant, is reduced.

In a further embodiment of the invention, the flight control device has a mechanism which is intended and suitable for getting caught in a plant. A flight control device arranged on the terminal reduces the risk of damage to the terminals, at the same time the flight control device positions the terminal in such a way that the sensor unit arranged in the terminal is arranged at an optimal distance from the objects (plants) to be monitored.

In a further embodiment of the invention, the flight control device has a parachute, a wing, a cable device, and/or a net. The flight control device reduces the fall speed and/or flight speed of the terminal during a flight and/or fall of the terminal, by which the risk of damage to the terminals upon impact in their impact position, for example on the ground or in a plant, is reduced. Parachute, cable device, and net are also suitable to function as a catch device to catch the terminal in a plant.

In addition, the flight control device can have a so-called ballute, a parachute-like braking parachute system, which is also used to generate air resistance, but has advantages especially when used in low air density and in the supersonic range. Ballutes have a balloon-like central body surrounded by an annular tube. The ring ensures a defined separation of the flow and thus ensures a stable flight attitude. The initial deployment is usually supported by active inflation using a gas cartridge or a small pyrotechnic propellant. Appropriately positioned air inlets then ensure slight excess pressure inside using ram air to prevent collapse due to the surrounding outside air flow.

In a further embodiment of the invention, the flight control device is a device for changing the external shape of the terminal. The device for changing the external shape of the terminal causes a change, in particular an increase, in the air resistance of the terminal. The risk of damage to the terminals when the terminals fall and/or fly is thus reduced, in particular when they impact in their impact position, for example on the ground or in a plant.

The device for changing the external shape of the terminal also or additionally causes a change in the orientation of the terminals during their flight and/or fall. This results in a change in the direction of flight and/or fall of the terminals; the ejected terminals are distributed over a larger area.

In a refinement of the invention, the device for changing the external shape is intended and suitable for changing the air resistance of the terminal. In particular, the braking device increases the air resistance and thus the flight and/or fall speed of the terminal. The risk of damage to the terminals when the terminals fall and/or fly is thus reduced, in particular when they impact in their impact position, for example on the ground or in a plant.

In an advantageous embodiment of the invention, the device for changing the external shape is intended and suitable for reducing the falling speed of the terminal in free fall, by which the risk of damage to the terminals upon impact in their impact position, for example on the ground or in a plant, is reduced.

In a further embodiment of the invention, the device for changing the external shape is intended and suitable for changing the orientation of the terminal in a free fall. This results in a change in the direction of flight and/or fall of the terminals; the ejected terminals are distributed over a larger area.

In a refinement of the invention, the device for changing the external shape has a folding and/or deployment mechanism. The folding and/or deployment mechanism causes an irreversible unfolding or deployment of the device to change the external shape. The folding and/or deployment mechanism is triggered by, for example, a timer, a signal, for example electromagnetic, or a mechanical event, for example by the air flow acting on the terminal.

In an advantageous embodiment of the invention, the folding and/or deployment mechanism has a parachute, wings, a net, or a cable device. A parachute, wings, a net, or a cable device reduces the fall speed and/or flight speed of the terminal during a flight and/or fall of the terminal, by which the risk of damage to the terminals upon impact in their impact position, for example on the ground or in a plant, is reduced. Parachute, cable device, and net are also suitable to function as a catch device to catch the terminal in a plant.

In a further embodiment of the invention, the flight control device is a device for changing the orientation of the terminal in a free fall. The device for changing the orientation of the terminal in a free fall changes the orientation of the terminal in a free fall. This results in a change in the direction of flight and/or fall of the terminals; the ejected terminals are distributed over a larger area.

The object is also achieved by means of the method for installing a terminal of a forest fire early detection system. Advantageous embodiments of the invention are set out in the dependent claims.

The method according to the invention for installing a terminal of a forest fire early detection system has two method steps: In the first method step, a dispensing device is loaded with a large number of terminals. The dispensing device is preferably part of an aircraft, e.g., a helicopter, airplane, airship, hot air balloon. The use of ballistic missiles, such as rockets, is also possible. The dispensing device can also be part of a water or ground vehicle, which is also designed to be off-road, or part of a hovercraft. The dispensing device can be part of a manned or unmanned, automatically and/or self-sufficiently controlled and/or remotely controllable means of transport or vehicle.

In the second method step, the terminals are dispensed by means of the dispensing device. The dispensing device dispenses the terminals at a time individually, in batches, and/or as a whole in or over the area in which the forest fire early detection system is to work. For this purpose, the dispensing device or the means of transport transporting the dispensing device has suitable means for determining the position of the dispensing device, for example a gyro navigation and/or GPS system. After being dispensed by the dispensing device, the terminals are arranged in a forest fire early detection system in such a way that the forest fire early detection system can monitor an area by means of the terminals.

In a refinement of the invention, the dispensing takes place in the direction of the intended final position of the terminals. The terminals are usually not self-propelled. The momentum exerted on the terminals during dispensing is used to move the terminals to their intended final position. The momentum acting on the terminals can be exerted on the terminals, for example, by the intrinsic movement of the dispensing device.

In an advantageous embodiment of the invention, the dispensing takes place several times, in particular the dispensing is repeated. The process of dispensing is repeated frequently enough that the provided number of terminals are arranged in the area or the section of the area in which the forest fire early detection system is to operate.

In a further embodiment of the invention, the dispensing device moves between a first and a second dispensing. This ensures that the terminals arranged in the dispensing device are distributed over a large area.

In a further embodiment of the invention, the distance between the position of the first dispensing and the position of the second dispensing is equidistant to the distance between the position of the second dispensing and the position of a third dispensing. This also ensures that the dispensing devices are distributed as evenly as possible in the area to be monitored.

In a refinement of the invention, the dispensing device is an aircraft or is positioned in an aircraft during dispensing. By means of an aircraft, a large number of devices can be distributed quickly and evenly within the area to be monitored. At the same time, an aircraft can also reach remote areas quickly. The aircraft itself is a helicopter, airplane, airship, or hot air balloon. The use of ballistic missiles, such as rockets, is also possible. The aircraft can be manned or unmanned, controlled automatically and/or self-sufficiently and/or controllable remotely.

In a further embodiment of the invention, dispensing takes place in batches. A plurality of terminals are therefore dropped at one time and/or at one dispensing position. Since damage to the terminals during dispensing and in particular during impact cannot be ruled out, redundancy is achieved by dispensing in batches. A region of the area to be monitored can therefore be monitored by a plurality of terminals.

In a refinement of the invention, the batches comprise more than 2, preferably more than 5 and particularly preferably more than 10 terminals. A plurality of terminals are therefore dispensed at one time and/or at one dispensing position. A region of the area to be monitored can therefore be monitored by a plurality of terminals.

In a further embodiment of the invention, the terminals have a dispensing trajectory after the dispensing, wherein the terminals experience a controlled momentum after the dispensing of the terminals, which changes the dispensing trajectory. The momentum acting on the terminals is exerted on the terminals, for example, by the intrinsic movement of the dispensing device during the dispensing. The momentum can be controlled, for example, by an intrinsic drive of the terminals. The momentum of the terminals is preferably controlled by changing the aerodynamics of an individual terminal, for example by arranging a parachute on the terminal.

In a refinement of the invention, the terminals of a batch have different dispensing trajectories. The dispensed terminals of a batch therefore also have different final positions from one another. This ensures that the dispensed terminals are distributed over a large area.

In a further embodiment of the invention, the dispensing takes place comprehensively in several dispensing positions. The dispensing positions are selected in such a way that a comprehensive arrangement of the dispensing devices within the forest fire early detection system is achieved.

In a further embodiment of the invention, the dispensing takes place in several dispensing positions in lines. The lines of the dispensing positions can also be arranged next to each other in a meandering shape to cover an area in order to achieve uniform coverage of the area to be monitored using the dispensing devices.

In a further embodiment of the invention, the dispensing direction comprises a directional component that is perpendicular to the direction of movement of the dispensing device. In order to achieve a comprehensive arrangement of ejected terminals in the area to be monitored, the dispensing direction has at least one directional component that is perpendicular to the direction of movement of the dispensing device. The dispensing device preferably dispenses the terminals to the sides that are arranged perpendicular to the direction of movement of the dispensing device.

In a further embodiment of the invention, a mechanism is triggered during the flight of the terminals, which decelerates the falling speed of the terminals. The risk of damage to the terminals when the terminals fall and/or fly is thus reduced, in particular when they impact in their impact position, for example on the ground or in a plant.

In an advantageous embodiment of the invention, during the flight of the terminals, a mechanism is triggered which activates a catch device which is intended and suitable for getting caught in a plant. A catch device arranged on the terminal reduces the risk of damage to the terminals, at the same time the catch device positions the terminal in such a way that the sensor unit arranged in the terminal is arranged at an optimal distance from the objects (plants) to be monitored.

In a refinement of the invention, a mechanism is triggered during the flight of the terminals, which causes a change of the aerodynamics in the direction of flight of the terminals. The change of the aerodynamics also causes a change in the direction of flight and/or fall of the terminals; the ejected terminals are therefore distributed over a larger area. Likewise, the ejected terminals decelerate the falling speed of the terminals, by which the risk of damage to the terminals is reduced.

In a refinement of the invention, a mechanism is triggered during the flight of the terminals, which causes a change in the orientation of the terminals to the direction of flight. The change in orientation also causes a change in the direction of flight and/or fall of the terminals; the ejected terminals are distributed over a larger area. Likewise, the ejected terminals decelerate the falling speed of the terminals, by which the risk of damage to the terminals is reduced.

The object is also achieved by means of the method for installing a forest fire early detection system. Advantageous embodiments of the invention are set out in the dependent claims.

The method according to the invention for installing a forest fire early detection system has two method steps: In the first method step, a dispensing device is loaded with a large number of terminals. The dropping device is preferably part of a means of transport such as an aircraft, for example a helicopter, airplane, airship, hot air balloon. It is also possible to use ballistic missiles, such as rockets, as the means of transport. A means of transport can also be a water or ground vehicle, even off-road, or a hovercraft. The means of transport can be unmanned, i.e., autonomously controlled and/or controllable remotely.

In the second method step, the terminals are dispensed by the dispensing device, wherein each individual one of the dispensed terminals is separately trackable. The dispensing device dispenses the terminals at a time individually, in batches, and/or as a whole in or over the area in which the forest fire early detection system is to work. For this purpose, the dispensing device has suitable means for determining the position of the dispensing device, for example a gyro navigation and/or GPS system. In addition, each terminal is trackable before and after the dispensing. “Separately trackable” in the sense of this document means that a position is known for each terminal. Preferably, the position of each terminal at the time the terminal is dispensed and/or in its final position within a forest fire early detection system is clearly known. This position can be the actual position of the terminal or a calculated position. The position is known independently of the position of other terminals. Furthermore, each terminal is uniquely identifiable, for example, by an ID identifier assigned to each terminal. After being dispensed by the dispensing device, the terminals are arranged in a forest fire early detection system in such a way that the forest fire early detection system can monitor an area by means of the terminals.

In a refinement, each of the terminals is assigned a separate ID. To uniquely identify each device, each device receives a separate and distinguishable ID identifier. This ID can be read, for example, using a barcode located on the terminal, an RFID chip and/or NFC.

In a further embodiment of the invention, the ID is stored on a central server. In a further embodiment of the invention, the dispensing position of each individual dispensed terminal is determined and/or stored. The dispensing position is the geographical position at which a terminal is dispensed by the dispensing device. In a further aspect of the invention, the dispensing position is different from the final position of the dispensed terminal. The dispensing position is usually, but not necessarily, different from the final position of the terminal, wherein the final position of a terminal designates the position of a terminal within a forest fire early detection system. By recording the dispensing position and the identification of each terminal, the dispensing position of each terminal can be precisely determined and stored on the central server.

In a further embodiment of the invention, the final position of the terminal is calculated. The determination of the final position of the terminal within the forest fire early detection system is preferably determined by means of the ballistic data during the time of ejection of the terminal. The ballistic data include, for example, direction of movement, drop position and height, speed of the dispensing device and the terminals at the time of dispensing of the terminals, as well as other parameters such as air pressure, air humidity, air temperature, wind direction, and wind strength.

In a further embodiment of the invention, the final position of the terminal is stored on a central server. When a forest fire is detected by one or more terminals, each terminal sends a corresponding signal to the central server. The location of the forest fire is defined by the positions of the corresponding terminals.

In an advantageous embodiment of the invention, the terminal sends an ID signal to a central server after reaching the final position of the terminal. In a refinement of the invention, the ID signal only has the ID of the terminal. In particular, the ID signal does not indicate the position of the terminal, which is not determined by the terminal itself, but is calculated based on preferably ballistic data during the dispensing of the terminal. The ID signal—usually sent as a data packet—therefore only has a small number of bits and requires only little energy to be sent. In addition, the final position can be determined and verified by means of data from triangulation measurements with other terminals.

The object is also achieved by means of the method for determining the position of a terminal of a forest fire early detection system.

The method according to the invention for determining the position of a terminal of a forest fire early detection system has four method steps: In the first method step, the terminal is identified. To uniquely identify each device, each device receives a separate and distinguishable ID identifier. This ID can be read, for example, by way of a barcode arranged on the terminal, a QR code, an RFID chip, and/or via NFC.

In the second step of the process, the dispensing position of the terminal is recorded. The dispensing position is the geographical position at which a terminal is dispensed by the dispensing device. The dispensing position is usually different from the final position of the terminal, wherein the (true) final position of a terminal designates the position of a terminal within a forest fire early detection system.

In the third method step, the dispensing position is assigned to an identified terminal. By recording the dispensing position and the identification of each terminal, the dispensing position of each terminal can be precisely determined.

In the fourth method step, data from the dispensing position and the identification of the terminal are stored. In addition, the dispensing position of each terminal is assigned to the respective terminal. The dispensing position of each terminal is therefore known by means of the method according to the invention.

In a refinement of the invention, identification is carried out by reading a barcode, QR code, an RFID chip, or via NFC, wherein the barcode and/or the corresponding chips are arranged on or in the terminal. The reading takes place immediately before the terminal is dispensed.

In a further embodiment of the invention, the dispensing position is determined by means of GPS. By means of GPS, the dispensing position of a terminal can be determined with an error of less than 10 m. In addition to GPS, other freely available satellite navigation systems (GNSS=Global Navigation Satellite Systems) can be used to determine the dispensing position, e.g., the Russian GLONASS and/or the GNSS Galileo of the EU.

In a further advantageous embodiment of the invention, the ballistic data from a dispensing of the terminal are determined. In a refinement of the invention, the ballistic data comprise the speed and/or direction of movement at the time of dispensing the terminals of a dispensing device used to dispense the terminal. The ballistic data also include, for example, dispensing position and altitude as well as other parameters such as air pressure, humidity, air temperature, wind direction, and wind strength. The ballistic data are at least partially known during the movement of the dispensing device and/or are determined during the movement of the dispensing device.

In a further embodiment of the invention, an impact position of the terminal is determined from the ballistic data and the dispensing position. The impact position refers to the position of the terminal at which the terminal first touches the ground and/or gets caught in a plant after the terminal has been dispensed. The impact position of the terminal, like the dispensing position of the terminal, is different from the final position of the terminal. The impact position of the terminal determined by means of the ballistic data and the dispensing position of the terminal deviates from the final position of the terminal.

For the operation of the forest fire early detection system, precise knowledge of the final position of a terminal in the monitoring area is irrelevant. By means of a comprehensive distribution of the terminals, such a scattered distribution of the terminals is achieved that the average distribution is at least 2 terminals/ha, preferably at least 5 terminals/ha, and particularly preferably at least 10 terminals/ha. It has been shown that such a distribution of terminals in the monitoring area is sufficient to detect a forest fire in the early phase of its development, for example as a smoldering fire.

In a further advantageous embodiment of the invention, the impact position determined from the ballistic data and the dispensing position is verified by means of data from triangulation measurements with other terminals. In addition, the impact position can be verified by means of data from triangulation measurements with other terminals, for example via measurements of the transit time of electromagnetic radio signals.

In a further embodiment of the invention, the terminal is ejected and/or dropped by means of a dispensing device. The dispensing device is preferably part of a means of transport such as an aircraft, for example a helicopter, airplane, airship, hot air balloon. The use of ballistic missiles, such as rockets, is also possible. The dispensing device can also be part of a water or ground vehicle, which is also designed to be off-road, or a hovercraft. The means of transport of the dispensing device can be manned or unmanned, controlled automatically and/or self-sufficiently and/or controllable remotely.

In a further embodiment of the invention, the terminal performs sensor functions and/or gateway functions during operation of the forest fire early detection system in addition to communicating with other components of the forest fire early detection system.

In an alternative embodiment of the invention, the terminal is a sensor for detecting a forest fire and has a sensor unit that detects a forest fire, for example by means of optical and/or electronic methods. In addition to heavy smoke, a forest fire produces a variety of gases, particularly carbon dioxide and carbon monoxide. The type and concentration of these gases are characteristic of a forest fire and can be detected and analyzed by means of suitable sensors. The signals detected by the sensor unit are analyzed with regard to the concentration of the composition of the gases. In addition, the temperature of the ambient air can be recorded by means of the sensor unit. In addition to the type and concentration of the gases produced in a forest fire, their temperature is an indicator of a forest fire. The occurrence and/or presence of a forest fire is concluded by combining the analyzed concentrations of the composition of the gases and/or from the analyzed temperatures. The type, composition, and temperature of the gases produced in a forest fire also indicate the occurrence of a forest fire.

LoRaWAN uses a star topology network architecture in which all the terminals communicate via the most suitable gateway. These gateways handle routing and, if more than one gateway is within range of a terminal and the local network is congested, they can also redirect communication to an alternative.

The star network architecture of LoRaWAN allows the terminals to enter the energy-saving idle state for long periods of time, thereby ensuring that the battery of the terminals is put under as little load as possible and can therefore be operated for several years without having to change the battery. A gateway functions as a bridge between simple protocols optimized for battery life (LoRa/LoRaWAN), which are better suited for resource-limit terminals ED, and the Internet Protocol (IP), which is used to provide IoT services and applications. After the gateway has received the data packets, such as measurement data, from the terminal via LoRa/LoRaWAN, it sends them via the Internet Protocol (IP) to a network server, which in turn has interfaces to IoT platforms and applications.

A terminal can also be designed in such a way that, in addition to the sensor function, it also carries out gateway functions. The forest fire early detection system then only requires a single component in addition to the network server to operate.

In a further embodiment of the invention, the dispensing position includes the dispensing position itself, the dispensing position assigned to the identification of the terminal, and/or data determined from the dispensing position. In addition to the actual dispensing position, the dispensing position is assigned to an identification of each individual terminal. In addition, the dispensing position can also comprise the ballistic data of the dispensing position. All of these mentioned data are stored.

### DESCRIPTION OF THE EXEMPLARY EMBODIMENTS

Exemplary embodiments of the terminal according to the invention and the forest fire early detection system according to the invention are shown schematically in simplified form in the drawings and are explained in more detail in the following description.

In the figures:

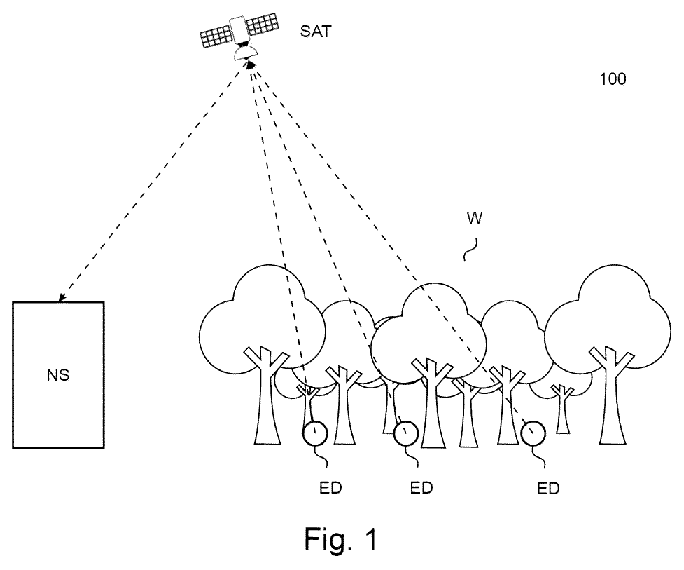

FIG. 1: shows a forest fire early detection system according to the invention, connection via satellite

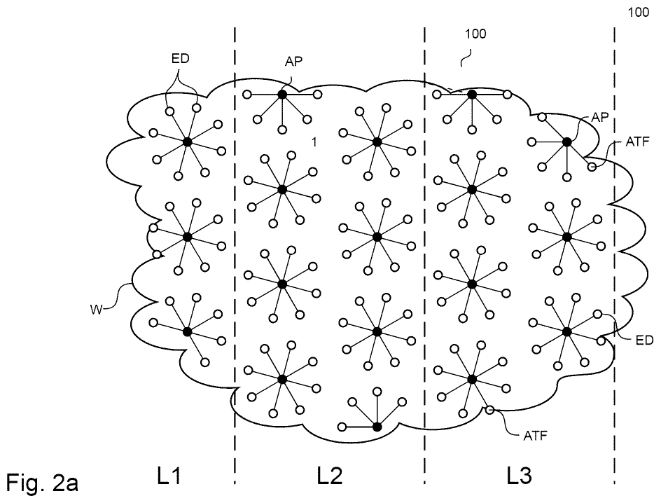

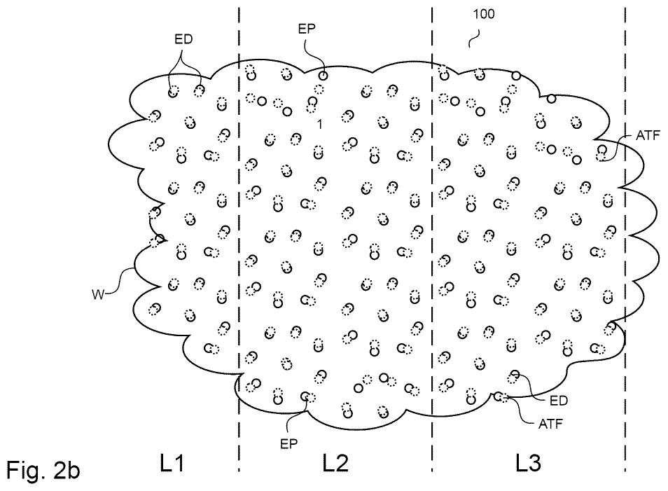

FIG. 2 a: shows a forest fire early detection system according to the invention, three output lines

FIG. 2 b: shows a distribution of the terminals in the forest fire early detection system, deviation of impact position-final position

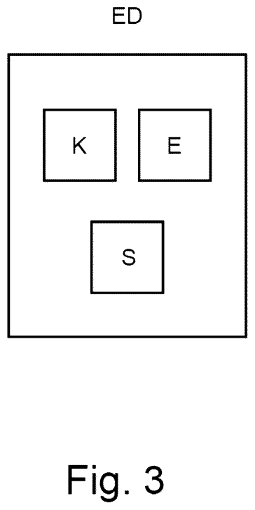

FIG. 3: shows a terminal according to the invention

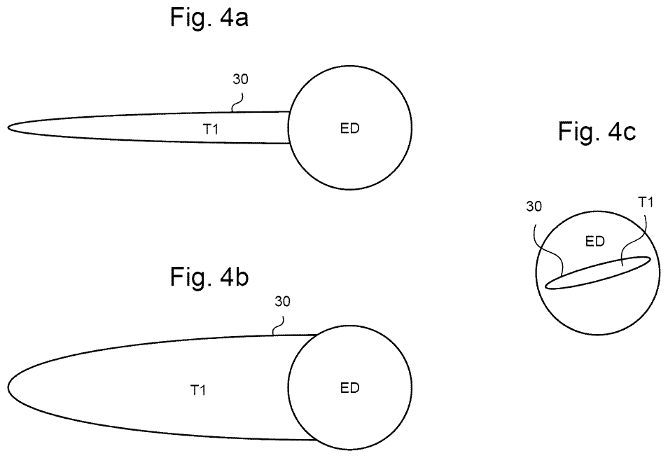

FIG. 4 a: shows a side view of a braking device

FIG. 4 b: shows a top view of a braking device

FIG. 4 c: shows a side view of a braking device

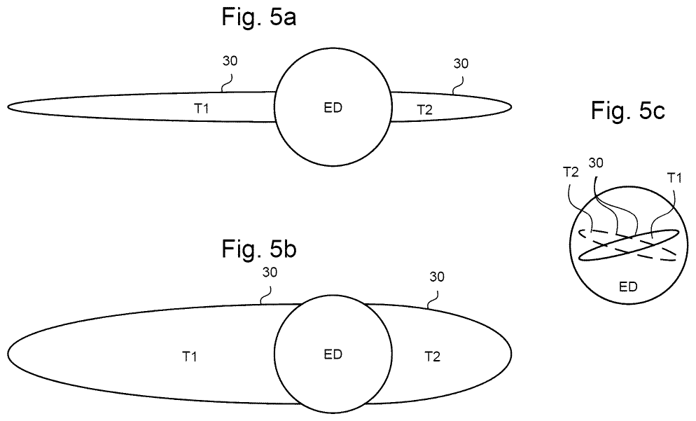

FIG. 5 a: shows a side view of an alternative embodiment of a braking device

FIG. 5 b: shows a top view of an alternative embodiment of a braking device

FIG. 5 c: shows a side view of an alternative embodiment of a braking device

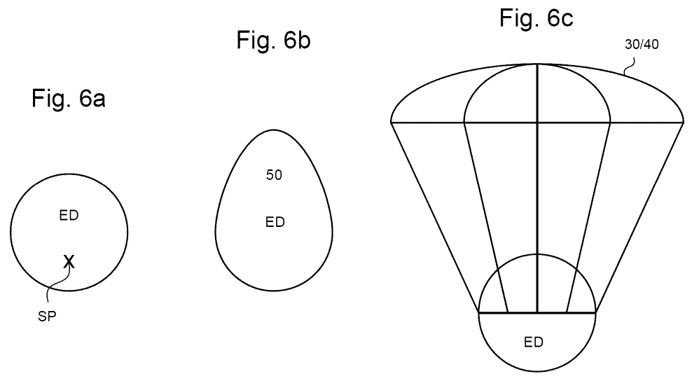

FIG. 6 a: shows a device for changing the orientation of a terminal and/or gateway

FIG. 6 b: shows an alternative embodiment of a device for changing the orientation of a terminal and/or gateway

FIG. 6 c: shows an alternative embodiment of a device for changing the external shape of a terminal and/or gateway

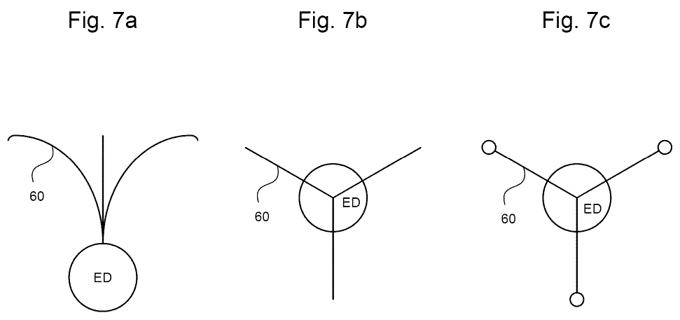

FIG. 7 a: shows a side view of a catch device

FIG. 7 b: shows a top view of a catch device

FIG. 7 c: shows a top view of a catch device

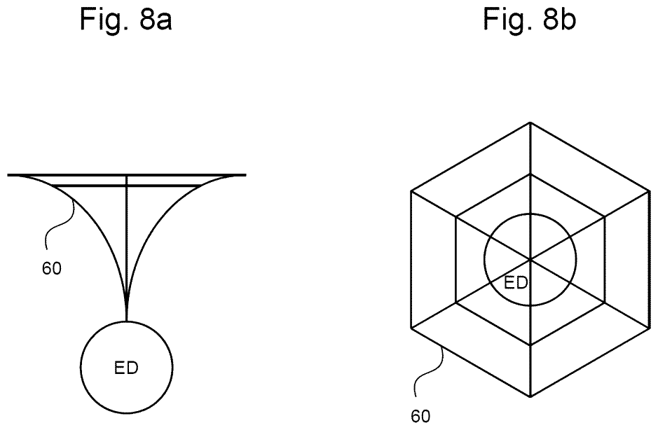

FIG. 8 a: shows a side view of a further embodiment of a catch device

FIG. 8 b: shows a topview of a further embodiment of a catch device

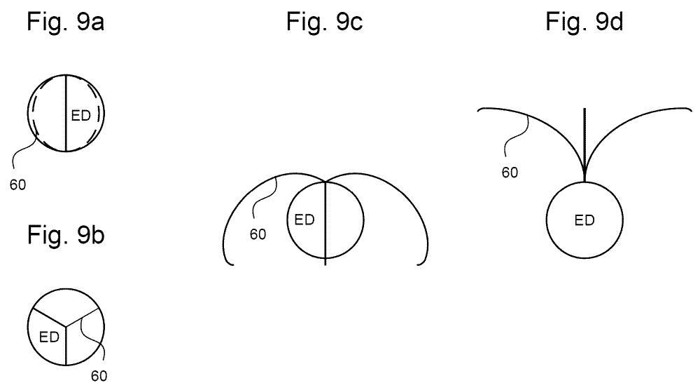

FIG. 9 a: shows a side view of a further embodiment of a catch device, folded in

FIG. 9 b: shows a top view of a further embodiment of a catch device, folded in

FIG. 9 c: shows a side view of a further embodiment of a catch device, folded out

FIG. 9 d: shows a top view of a further embodiment of a catch device, folded out

FIG. 1 shows an exemplary embodiment of a forest fire early detection system 100 according to the invention. In this exemplary embodiment, each terminal ED is arranged in a final position EP on the ground of the monitoring area W, in this and all other exemplary embodiments a forest, but the terminals ED can also have final positions EP at a distance from the ground in that they are arranged in the plants by means of catch devices 60 (see FIG. 7, FIG. 8, FIG. 9). The terminals ED are directly connected to a satellite SAT and record the temperature of the ambient air. If the recorded temperature exceeds a threshold temperature, the relevant terminal ED sends ID data via the satellite SAT to the server NS and thus detects a forest fire.

An exemplary embodiment of a forest fire early detection system 100 according to the invention in the monitoring area W and the terminals ED arranged therein is shown in FIG. 2. To install the forest fire early detection system 100, a dispensing device is loaded with a large number of terminals ED. The terminals ED are dispensed by means of the dispensing device. The terminals ED are dropped in batches (FIG. 2 a) in such a way that the dispensing device covers an equal distance between the individual drops of a batch. The dispensing trajectory of the individual terminals ED of a batch are different, the terminals ED of a batch therefore have different impact positions ATF. The individual drops can also take place in multiple dispensing positions AP in such a way that multiple dispensing positions AP each lie along a drop line L1, L2, L3 (FIG. 2 a). The drop line L1 has a plurality of dispensing positions AP, each of a batch of terminals ED, as do the drop lines L2 and L3. In this way, a large-scale distribution of the terminals ED is achieved.

With each of the multiple drops at a drop position AP, a batch of nine terminals ED is dropped. The batches have more than two, preferably more than five, and particularly preferably more than ten terminals ED in such a way that the drop takes place comprehensively, in other words the installed forest fire early detection system 100 has terminals ED at the most regular spatial distances possible from one another (FIG. 2 b).

For the forest fire early detection system 100 to function correctly, knowledge of the final position EP of the terminal ED within the forest fire early detection system 100 is important. In the simplest case, the terminal ED itself has a GNSS system and transmits its final position EP in the forest fire early detection system 100 to the Internet network server NS. However, the GNSS system requires electrical energy and can fail, especially during ejection and the impact of the terminal ED on the ground.

Therefore, the determination and calculation of the impact position ATF of the terminal ED takes place within the forest fire early detection system 100. The impact position ATF is different from the (true) final position EP of the terminal ED, which is not determined by means of the method according to the invention for determining the position of a terminal ED, in contrast to the impact position ATF of a terminal ED. The final position EP has a deviation from the impact position ATF of the terminal ED.

For the operation of the forest fire early detection system 100, precise knowledge of the final position EP of a terminal ED in the monitoring area W is irrelevant. By means of comprehensive dispensing of the terminals ED by the dispensing device 10, such a scattered distribution of the terminals is achieved that an average distribution is at least 2 terminals ED/ha, preferably at least 5 terminals ED/ha, and particularly preferably at least 10 terminals ED/ha. In this exemplary embodiment, the average distribution of the terminals ED is 9/ha. It has been shown that such a distribution of terminals ED in the monitoring area W is sufficient to detect a forest fire in the early phase of its development, for example as a smoldering fire.

Each terminal ED stored in the reservoir has a unique identifier (ID). Each ID of each terminal ED is stored on the network server NS. To determine the position of a terminal ED after reaching the final position of the terminal ED, the terminal ED is first uniquely identified. This is done by reading a barcode or QR code arranged on the terminal ED. The terminal ED can also have an RFID chip, the identifier of which is read by means of a reader based on Near Field Communication (NFC).

When the terminal ED is ejected, the dispensing position AP is determined. The position of the means of transport 1 is usually constantly recorded, also in order to control the movement of the means of transport 1. At the time of ejection of the terminal ED, its dispensing position AP is determined by means of a GNSS system arranged in the means of transport 1 and assigned to the respective terminal ED. Dispensing position AP and assigned identification of the terminal ED are stored.

The determination and calculation of the impact position ATF of a terminal ED is carried out by means of the ballistic data at the time the terminal ED is dispensed. The ballistic data include, for example, direction of movement, drop position and height, speed of the dispensing device 10 and the terminals ED at the time of dispensing of the terminals ED, as well as other parameters such as air pressure, air humidity, air temperature, wind direction, and wind strength. The ballistic data are at least partially known during the movement of the means of transport 1 and read in by the database and/or are determined during the movement of the means of transport 1, for example by means of the position determination system of the means of transport 1.

After reaching the final position of the terminal ED, the terminal ED sends an ID signal to the central server NS, on which the final position is stored together with the ID of the respective terminal ED.

During operation of the forest fire early detection system 100, a terminal ED sends a status message to the server NS at regular intervals, wherein the status message only comprises the data for identification (ID data) of the terminal ED. This sending of the ID status message only requires at most half of the energy stored in the energy storage device E of the terminal ED (see FIG. 3). This ensures that the energy storage device E of the terminal ED still has sufficient energy reserves to send a warning message to the server NS in the event of a forest fire.

The forest fire early detection system 100 can have, instead of satellite communication (see FIG. 1), a mesh gateway network arranged in a forest W that uses the technology of a LoRaWAN network. The forest fire early detection system 100 then has a large number of terminals ED, which are connected to gateways via a single-hop connection FSK. The mesh gateways are connected to each other and partly to border gateways. The border gateways are connected to the Internet network server NS, either via a wired connection WN or via a wireless connection by means of the Internet protocol IP. The LoRaWAN network has a star-shaped architecture in which message packets are exchanged between the terminals ED having the sensors for detecting a forest fire and a central Internet network server NS by means of gateways. The terminals ED can also carry out their functions like a gateway.

FIG. 3 shows schematically the structure of the terminals ED arranged in the forest fire early detection system 100. The terminal ED has the communication device K, the energy supply E, and the sensor S. Each terminal arranged ED in the forest fire early detection system 100 has a separate, i.e., unique ID, by means of which the respective terminal ED is uniquely identifiable

The terminal ED is a sensor for detecting a forest fire. To be able to install and operate the terminal ED in inhospitable and especially rural areas far away from energy supplies, the terminal ED is equipped with a self-sufficient energy supply E. In this exemplary embodiment, energy supply E and the sensor S for recording the temperature of the ambient air are combined in one device. For this purpose, a bimetal lamella and a piezo element are arranged in the terminal ED. A bimetal lamella has two layers of different metals lying one above the other. The two layers are connected to one another by material bonding or by a form-fitting material. Due to the different coefficients of thermal expansion of the metals used, one of the layers expands more than the other, causing the bimetal lamella to bend when the temperature changes.

The energy conversion device is a piezo element and/or an electret-based capacitive converter. This deformation of the bimetal lamella due to thermal action is converted into electrical energy by a piezoelectric material, which is deformed or shaken when the bimetal lamella bends. A piezo element generates electrical voltage when force is applied by pressure or vibration, i.e., it uses kinetic energy in the environment. The output power is largely determined by the mechanical deformation of the bending structure. The greater the deflection, the greater the charge and power generated. The bimetal lamella has a transition temperature at which the bimetal lamella changes from a first resting state to a second resting state. The transition temperature of the bimetal lamella, 80° C. here, is advantageously the threshold temperature at which the terminal ED detects a forest fire. During the transition, the bimetal lamella generates electrical energy, which is also, for example, generated to send the communication unit K a warning message via the satellite SAT to the server NS immediately before the warning message is sent. The warning message comprises the ID data of the terminal ED. The server NS therefore only receives the information on which terminal ED within the forest fire early detection system 100 the threshold temperature was exceeded.

Optionally, the electrical energy generated at the critical temperature can be stored in a supercapacitor. The stored electrical energy can be used to send, in addition to the ID data of the terminal ED, further data, such as the temperature and recorded data from other sensors S possibly arranged in the terminal ED, to the server NS.

The use of solar cells is somewhat more complex and cost-intensive, but is an energy supply E that offers a very long service life for the terminal ED. In addition to the energy conversion by the solar cell, a memory and power electronics (not shown) are also arranged in the terminal ED. The energy supply E can also be a super capacitor, but in the simplest case a battery can be used, which can also be designed to be rechargeable. The terminal ED then has a continuous energy supply E, using which the terminal ED is able to send a status message to the server NS at regular intervals, here every 24 hours, to indicate the functionality of the terminal ED. The status message only has the ID data of the terminal ED, not its final position EP within the forest fire early detection system 100. As explained, the final position EP of a terminal ED is not known exactly.

In addition, a terminal ED can have further sensors S. The sensor unit S can also be designed in two stages and have a plurality of sensors for detecting a forest fire. In addition to heavy smoke, a forest fire produces a variety of gases, particularly carbon dioxide and carbon monoxide. The type and concentration of these gases are characteristic of a forest fire and can be detected and analyzed by means of suitable sensors. The signals detected by the sensor unit S are analyzed with regard to the concentration of the composition of the gases. If a concentration of the gases is exceeded, a forest fire is detected.

In addition, the temperature of the gases can be analyzed by means of the sensor unit S. In addition to the type and concentration of the gases produced in a forest fire, their temperature is an indicator of a forest fire. The occurrence and/or presence of a forest fire is concluded by combining the analyzed concentrations of the composition of the gases and/or from the analyzed temperatures. The type, composition, and temperature of the gases produced in a forest fire also indicate the occurrence of a forest fire. This makes it possible to detect an emerging forest fire and to combat it at an early stage.

By means of the communication device K, messages from the terminal ED, in particular measurement data and the ID signal, are sent wirelessly as a data packet to a satellite SAT or a plurality of satellites SAT or, in the case of using a LoRaWAN, to a gateway G by means of a single-hop connection FSK via LoRa (chirp frequency spread modulation) or frequency modulation. The communication device K only has a transmitting device, the terminal ED can therefore not receive any data via the communication device K. The terminal ED is therefore designed to be lighter, simpler, and more cost-effective, and its power consumption is also reduced. The terminal ED has a mass of less than 500 g, preferably less than 250 g, and particularly preferably less than 200 g. In this exemplary embodiment, the mass of the terminal ED is 50 g.

An exemplary embodiment of a braking device 30 arranged on a terminal ED is shown in FIG. 4. The terminal ED has a wing T1 in the form of a wing (FIG. 4 c) such that the center of mass of the terminal ED with braking device 30 is not arranged in its geometric center point (FIGS. 4 a, b). The terminal ED with arranged braking device 30 therefore has different cW values in different spatial directions.

After the terminal ED with arranged braking device 30 is dispensed, it moves in the direction of the ground with increasing speed due to gravity. In flight, the terminal ED with arranged braking device 30 arranged lies flat and begins to rotate around an axis extending through the terminal ED. This autorotation occurs in such a way that the terminal ED is on the inside and the one-sided wing T1 is on the outside. The autorotation enables the terminal ED to optimally expose the wing surface to the air flow and in this way reduce the rate of descent. The autorotation of the wing T1 with the wing surface around the vertical axis generates the helical circle surface. Air flows through this helical circle surface from bottom to top.

Due to the braking device 30, not only is the falling speed of the terminal ED and thus the risk of damage to the terminal ED reduced, but also the direction of flight of the terminal ED is changed in relation to the direction of movement of the means of transport 1, for example due to the prevailing air direction (wind direction). The distribution of the plurality of terminals ED ejected in batches within the forest fire early detection system 100 over a larger area is thus ensured.

FIG. 5 shows a variant of the previous exemplary embodiment (see FIG. 4). The terminal ED has the braking device 30 having two wings T1, T2, wherein the area of the two wings T1, T2 is different from one another. The wings T1, T2 are arranged on opposite sides of the terminal ED (FIGS. 5 a, b); their cross sections are at an angle to one another (FIG. 5 c). After the terminal ED with arranged braking device 30 is dropped, the terminal ED is also set in rotation, the falling speed and thus the risk of damage to the terminal ED are reduced.

FIG. 6 shows exemplary embodiments of devices arranged on the terminal ED for changing the external shape 40 and devices arranged on the terminal ED for changing the orientation 50. A simple but effective method for changing the orientation during the flight and/or fall of the terminal ED after it is dropped is an arrangement of the center of mass SP not at the geometric center point of the spherical terminal ED, but at a distance from it (FIG. 6 a). The air resistance of the terminal ED is therefore changed during flight and/or fall. The terminal ED in this way goes into a spin during its flight and/or fall and thus changes its direction in relation to the direction of movement of the means of transport 1, by which the distribution of the plurality of terminals ED ejected in batches within the forest fire early detection system 100 over a larger area is achieved.

Another method for changing the orientation during flight and/or fall of the terminal ED after it is dropped is to externally shape the terminal ED into an external shape that is not spherical (FIG. 6 b). This terminal ED also goes into a spin during its flight and/or fall and thus changes its direction in relation to the direction of movement of the means of transport 1.

By arranging a parachute as a braking device 30 and at the same time a device for changing the external shape 40 on the terminal ED (FIG. 6 c), multiple effects are achieved. The parachute 30, 40 is usually wrapped around the terminal ED and opens immediately after the terminal ED is dropped. The parachute 30, 40 increases the air resistance during the flight and/or fall of the terminal ED in such a way that the falling speed of the terminal ED is reduced enough that the risk of damage to the terminal ED upon impact with the ground is reduced.

At the same time, the air resistance of the terminal ED is increased during its flight and/or fall in such a way that the terminal ED is engaged by the prevailing air direction (wind direction). The distribution of the plurality of terminals ED ejected in batches within the forest fire early detection system 100 over a larger area is thus enabled.

In addition, the parachute 30, 40 can be used as a catch device 60. The parachute 30, 40 is suitable for getting caught in a plant, for example in the crown of a tree. The terminal ED is then arranged within the forest fire early detection system 100 in such a way that the terminal ED is at a distance from the ground. This reduces the risk of subsequent damage to the terminal ED, for example from animals and/or vandalism.

A further exemplary embodiment of a catch device 60 is shown in FIG. 7. The terminal ED has a spherical shape, the catch device 60 is fastened to the spherical surface (FIG. 7 a). The catch device 60 has three arms, each of which has a solid ball at one end (FIG. 7 b, c). The catch device 60 is suitable for getting caught in a plant by the balls hooking in branches of, for example, trees.

FIG. 8 shows a further exemplary embodiment of a catch device 60, which is designed as a net. The terminal ED also has a spherical shape, the catch device 60 is fastened to the spherical surface (FIG. 8 a). The net 60 has a hexagonal external shape (FIG. 8 b), wherein the meshes of the net 60 are suitable for getting caught in plants. The net 60 is wrapped around the terminal ED before it is dropped and opens immediately after the terminal ED is dropped. In addition, the air resistance of the terminal ED is increased during its flight and/or fall and thus the flight or fall speed of the terminal ED is reduced.

A further exemplary embodiment of a catch device 60 is shown in FIG. 9. The catch device 60 has a deployment and/or folding mechanism. The terminal ED is also designed as a sphere. When the terminal ED is stored in the reservoir of the means of transport 1 before the terminal ED is dropped, the catch device 60 is folded in (FIGS. 9 a, b) and is not functional. After the terminal ED has been dropped, the deployment and/or folding mechanism unfolds the catch device 60 in such a way (FIG. 9 c) that the respective ends of the catch device 60, which are designed as hooked, can catch in a plant. In this exemplary embodiment, the catch device 60 is also designed in such a way that the unfolded catch device 60 (FIG. 9 d) increases the air resistance of the terminal ED during its flight and/or fall and thus reduces the flight or falling speed of the terminal ED.

### LIST OF REFERENCE NUMERALS

1 means of transport/vehicle
10 dispensing device
21, 22, 23, 24, ejection device 25, 26, 27
AP dispensing position
ATF impact position
EP final position
ED terminal
G gateway
K communication device
E energy supply
S sensor unit
30 braking device
40 device for changing the external shape
50 device for changing the orientation
60 catch device
70 forest fire early detection system installation device
T1, T2 wing
SP center of mass
L1, L2, L3, L4, drop line
L5
SAT satellite
FSK frequency modulation
IP Internet protocol
MHF multi-hub wireless network
NS Internet network server
W monitoring area
WN wired connection
BGD border gateway
100 forest fire early detection and/or forest fire risk monitoring system

1. A method for operating a forest fire early detection system (100) having the following method steps
Recording a temperature by way of a terminal (ED)
Sending ID data from the terminal (ED) to a server (NS),
wherein the position of the terminal (ED) is unknown.

2. The method for operating a forest fire early detection system (100) according to claim 1
characterized in that
the recorded temperature is compared with a threshold temperature.

3. The method for operating a forest fire early detection system (100) according to claim 2
characterized in that
the ID data are sent when the recorded temperature exceeds the threshold temperature.

4. The method for operating a forest fire early detection system (100) according to claim 1
characterized in that
the position of the terminal (ED) remains unknown.

5. The method for operating a forest fire early detection system (100) according to claim 1
characterized in that
The communication from the terminal (ED) to the server (NS) takes place via a satellite connection.

6. The method for operating a forest fire early detection system (100) according to claim 1
characterized in that
a large number of terminals (ED) are scattered in a monitoring area (W).

7. The method for operating a forest fire early detection system (100) according to claim 1
characterized in that
the exact position of the terminals (ED) cannot be determined by elements of the forest fire early detection system (100).

8. The method for operating a forest fire early detection system (100) according to claim 1
characterized in that
the ID data are part of a status message for monitoring the functionality of the terminals (ED) and/or part of a warning message.

9. The method for operating a forest fire early detection system (100) according to claim 1
characterized in that
the terminals (ED) send status messages to the server (NS) at regular intervals.

10. The method for operating a forest fire early detection system (100) according to claim 9,
characterized in that
the status messages only comprise data for identifying the terminal (ED).

11. The method for operating a forest fire early detection system (100) according to claim 9,
characterized in that
sending the ID status messages consumes at most half of the energy stored in the terminal (ED).

12. The method for operating a forest fire early detection system (100) according to claim 1
characterized in that
the energy for sending a warning message is generated immediately before the warning message is sent.

13. A terminal (ED) of a forest fire early detection system (100) having
a self-sufficient energy supply (E),
a communication device (K), and
a flight control device (30), which is intended and suitable for changing the falling speed of the terminal (ED) and/or the direction of flight.

14. The terminal (ED) of a forest fire early detection system (100) according to claim 13,
characterized in that
the flight control device (30) is a braking device.

15. The terminal (ED) of a forest fire early detection system (100) according to claim 13,
characterized in that
the cW value of the terminal (ED) is different in two different directions.

16. A terminal (ED) of a forest fire early detection and/or forest fire risk monitoring system (100) according to claim 14,
characterized in that
the braking device (30) is intended and suitable for changing the air resistance of the terminal (ED).

17. The terminal (ED) of a forest fire early detection system (100) according to claim 14,
characterized in that
the braking device (30) has a mechanism which is intended and suitable for changing the orientation of the terminal (ED) to a direction of flight of the terminal (ED).

18. The terminal (ED) of a forest fire early detection system (100) according to claim 14,
characterized in that
the braking device (30) has a mechanism which is intended and suitable for changing the direction of flight of the terminal (ED).

19. The terminal (ED) of a forest fire early detection system (100) according to claim 14,
characterized in that
the braking device (30) has a mechanism which is intended and suitable for decelerating the fall speed and/or the flight speed of the terminal (ED) during a flight and/or fall of the terminal (ED).

20. The terminal (ED) of a forest fire early detection system (100) according to claim 14,
characterized in that
the braking device (30) has a mechanism which is intended and suitable for getting caught in a plant.

21. The terminal (ED) of a forest fire early detection system (100) according to claim 14,
characterized in that
the braking device (30) has a parachute, a wing, a cable device, and/or a net.

22. The terminal (ED) of a forest fire early detection system (100) according to claim 13,
characterized in that
the flight control device (30) is a device (40) for changing the external shape of the terminal (ED).

23. The terminal (ED) of a forest fire early detection system (100) according to claim 22,
characterized in that
the device (40) for changing the external shape is intended and suitable for changing the air resistance of the terminal (ED).

24. The terminal (ED) of a forest fire early detection system (100) according to claim 23,
characterized in that
the device (40) for changing the external shape is intended and suitable for reducing the falling speed of the terminal (ED) in free fall.

25. The terminal (ED) of a forest fire early detection system (100) according to claim 22,
characterized in that
the device (40) for changing the external shape is intended and suitable for changing the orientation of the terminal (ED) in a free fall.

26. The terminal (ED) of a forest fire early detection system (100) according to claim 22,
characterized in that
the device (40) for changing the external shape has a folding and/or deployment mechanism.

27. The terminal (ED) of a forest fire early detection system (100) according to claim 26,
characterized in that
the folding and/or deployment mechanism has a parachute, wings, a net, or a cable device.

28. The terminal (ED) of a forest fire early detection system (100) according to claim 13,
characterized in that
the flight control device is a device (50) for changing the orientation of the terminal (ED) in a free fall.

29. The terminal (ED) of a forest fire early detection system (100) according to claim 28,
characterized in that
the device (50) for changing the orientation of the terminal (ED) in a free fall is intended and suitable for changing the air resistance of the terminal (ED).

30. The terminal (ED) of a forest fire early detection system (100) according to claim 29,
characterized in that
the device (50) for changing the orientation of the terminal (ED) in a free fall is intended and is suitable for reducing the falling speed of the terminal (ED) in free fall.

31. The terminal (ED) of a forest fire early detection system (100) according to claim 28,
characterized in that
the device (50) for changing the orientation of the terminal (ED) in a free fall is intended and suitable for changing the external shape of the terminal (ED) and/or gateway.

32. The terminal (ED) of a forest fire early detection system (100) according to claim 28,
characterized in that
the device (50) for changing the orientation of the terminal (ED) in a free fall has a folding and/or deployment mechanism.

33. The terminal (ED) of a forest fire early detection system (100) according to claim 32,
characterized in that
the folding and/or deployment mechanism has a parachute, wings, a net, or a cable device.

34. The terminal (ED) of a forest fire early detection system (100) according to claim 13,
characterized in that
the flight control device is a catch device (60) which is intended and suitable for getting caught in a plant.

35. The terminal (ED) of a forest fire early detection system (100) according to claim 34,
characterized in that
the catch device (60) has a folding and/or deployment mechanism.

36. The terminal (ED) of a forest fire early detection system (100) according to claim 35,
characterized in that
the folding and/or deployment mechanism has a parachute, wings, a net, or a cable device.

37. The terminal (ED) of a forest fire early detection system (100) according to claim 34,
characterized in that
the catch device (60) is intended and suitable for changing the air resistance of the terminal (ED).

38. The terminal (ED) of a forest fire early detection system (100) according to claim 37,
characterized in that
the catch device (60) is intended and suitable for reducing the falling speed of the terminal (ED) in free fall.

39. The terminal (ED) of a forest fire early detection system (100) according to claim 34,
characterized in that
the catch device (60) is intended and suitable for changing the external shape of the terminal (ED).
